(19) United States
(12) Patent Application Publication
(10) Pub. No.: US 2006/0206552 A1
(43) Pub. Date: Sep. 14, 2006

(54) Method of ofdm transmission in a millimetre-wave wland and corresponding system

(76) Inventors: Claudio Borean, Torino (IT); Tiziana Tambosso, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/551,419

(22) PCT Filed: Mar. 31, 2003
(86) PCT No.: PCT/IT03/00189

§ 371 Date: Sep. 30, 2005

(51) Int. Cl. G06F 17/14

(52) U.S. Cl. 708/400

(57) ABSTRACT

A method of managing an OFDM transmission system, for instance a millimetre-wave WLAN, wherein a plurality of sets of samples including at least one set (X₁, X₂, . . . X_{N}) of generally non-zero samples is subject to an integral transform transmitted in the integral-transformed format and subject to a complementary integral transform to reconstruct the at least one set of generally non-zero samples. The method includes the step of assigning non-overlapping sets of samples to a plurality of terminals.

### FIELD OF THE INVENTION

The present invention relates to transmission systems based on the operating scheme usually referred to as OFDM (Orthogonal Frequency Domain Multiplex) and was developed by paying specific attention to the possible application to wireless local area networks (currently referred to as W-LANs or WLANs) such as millimetre-wave WLAN systems. Reference to this preferred field of application is not to be construed as intended to limit the scope of applicability of the invention: in fact the invention can be advantageously applied to other carriers than a millimetre-wave carrier and to communication systems other than a WLAN.

### DESCRIPTION OF THE RELATED ART

In an OFDM transmission system, a set of non-zero samples (information samples) is subject to an integral transform (such as an Inverse Fast Fourier Transform or IFFT), transmitted in such an integral-transformed format and subject to a complementary integral transform (such as a FFT) to reconstruct the non-zero samples transmitted.

Current WLAN standards such as IEEE 802.11a and IEEE 802.11b provide for all the stations located in a certain access area being connected by sharing only one channel at a time. This represents a strong limitation in view of the requests for an ever-increasing bandwidth being made available for broadband services such as video streaming and fast Internet access.

This fact is acknowledged e.g. in “The AC006 MEDIAN Project-Overview and the State of the Art” by C. Ciotti and J. Borowski, Summit Granada-SPAIN, November 1996, available with the Institute for Mobile and Satellite Communications (IMST) of Kamp-Lintfort, Germany.

One of the main objectives of the MEDIAN Project is the development and standardization of high-speed wireless costumer premises local area network for multimedia applications in the 60 GHz range (with a net data rate up to 150 Mbit/s) connected to the fixed Asynchronous Transfer Mode (ATM) network. The MEDIAN system architecture uses an orthogonal frequency domain multiplex (OFDM) modulation scheme characterized by 512 sub-carriers.

As in existing standards, in the arrangement according to the MEDIAN Project, only a single channel (200 MHz) is used to implement a WLAN network, and such a channel corresponds to the set of non-zero samples above described.

Consequently, multiple receiver/transmitter modules, each using a distinct band (i.e. a distinct OFDM transmission system each using a distinct band), are required in order to operate over a larger transmission band.

Such prior art arrangements fail to recognize that the use of millimetre-wave carriers (e.g. in the range between 40-60 GHz) makes it possible to allocate to the users a much larger frequency band (for instance 4-5 GHz) in comparison with existing WLAN systems as described in the standards such as IEEE 802.11a e IEEE 802.11b.

### OBJECTS AND SUMMARY OF THE PRESENT INVENTION

The object of the present invention is thus to provide an improved arrangement taking advantage of the availability of a larger frequency band to be allocated around millimetre-wave carriers or sub-millimetre-wave carriers used in WLAN networks.

According to the present invention, such an object is achieved by means of a method having the features set forth in the claims that follow. The present invention also relates to a corresponding system, to terminals for use in such a system, as well as corresponding computer program products directly loadable into the memory of a computer and including software code portions performing the method of the invention and/or implementing a terminal for use in the network according to the invention when the product is run on a computer.

A preferred embodiment of the invention is thus a method of managing one OFDM transmission system, wherein a plurality of sets of samples including at least one set (X₁, X₂, . . . X_{N}) of a generally non-zero samples is subject to an integral transform, transmitted in the integral-transformed format and subject to a complementary integral transform to reconstruct the set of generally non-zero samples.

The preferred method provides the steps of including in said system a plurality of terminals (i.e. stations), assigning to these terminals respective non-overlapping sets of samples or positions within said plurality of sets of samples, and transmitting the samples pertaining to each terminal by inserting the non-zero samples to be transmitted (X₁, X₂, . . . X_{N}) in the respective positions assigned to the terminal.

Preferably, the system includes at least one further terminal intended to operate as an access point and adapted for exchanging samples with said plurality of terminals. The further terminal subjects to at least one of the integral transform or the complementary integral transform a plurality of sets of samples including at least two non-overlapping sets of non-zero samples pertaining to two respective different terminals of said plurality.

The integral transform is preferably selected from the group consisting of the Fast Fourier Transform (FFT) and the Inverse Fast Fourier Transform (IFFT).

In particular, the arrangement described herein takes advantage of the frequency band available to the users of a millimetre-wave WLAN network or sub-millimetre-wave WLAN network by causing a plurality of stations located in a given area to use, simultaneously, a corresponding plurality of channels.

This is contrary to existing WLAN standards, which refer to only one channel being used at a time for each access area.

The invention can be used, moreover, with frequency band in the range of standard WLAN, by scaling, accordingly, the carrier and the corresponding band.

The arrangement described herein is based on the recognition of the fact that the OFDM coding scheme carries within itself the criterion of orthogonality of the symbols transmitted.

The arrangement described herein implements, in particular, an efficient multiplex system and an improved interface for a millimetre-wave transmitter/receiver module, exploiting the inherent broadband characteristics of a millimetre-wave carrier.

The arrangement described herein complies in an efficient and flexible way with the demand for growing wide bands, while using only one millimetre-wave module to manage the plurality of independent channels at the same time. Management of multiple stations is performed digitally.

### BRIEF DESCRIPTION OF THE ANNEXED DRAWINGS

The invention will now be described, by way of example only, by referring to the enclosed figures of drawing, wherein:

FIG. 1 is a block diagram representing a typical WLAN network architecture,

FIG. 2 schematically represents a millimetre-wave transmitter/receiver station (transceiver),

FIG. 3 details a millimetre-wave WLAN net interface,

FIG. 4 is a block diagram portraying millimetre-WLAN channel management in a local station, and

FIG. 5 is a block diagram portraying millimetre-WLAN channel management in an access point.

### DETAILED DESCRIPTION OF A PREFERRED EMBODIMENT OF THE INVENTION

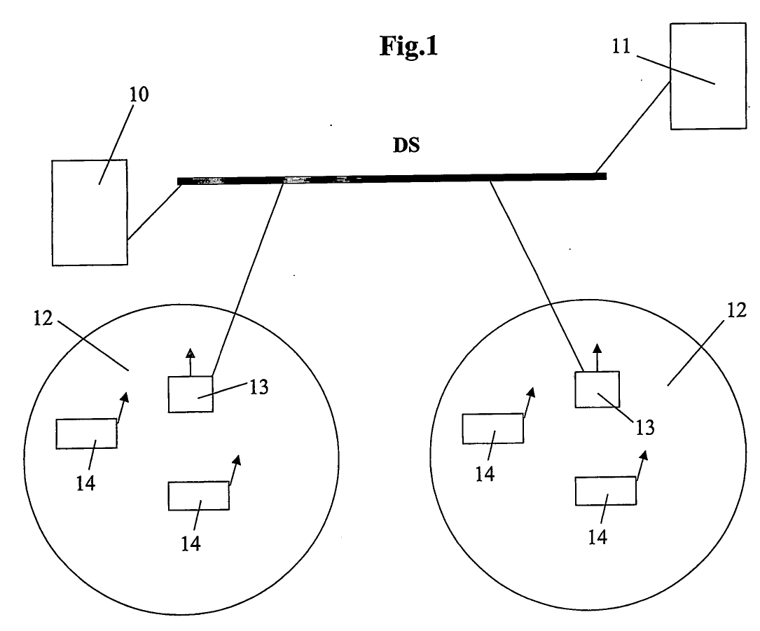

FIG. 1 depicts a typical example of millimetre-wave WLAN (mm-WLAN) network architecture.

In the diagram of FIG. 1, reference numerals 14 indicates respective terminals such as PCs, mobile phones, and so on each provided with a respective mm-WLAN card intended to permit communication with a respective access point 13 serving a corresponding access area 12.

Communication with other access areas 12 is via a distribution system DS comprised e.g. of Gbit Ethernet or fibre optic network. The distribution system DS connects the various access points 13 serving the access areas 12. A server 10 and a gateway 11 are usually provided in order to permit access to shared databases (through the server 10) or to external networks such as the Internet (through the gateway 11).

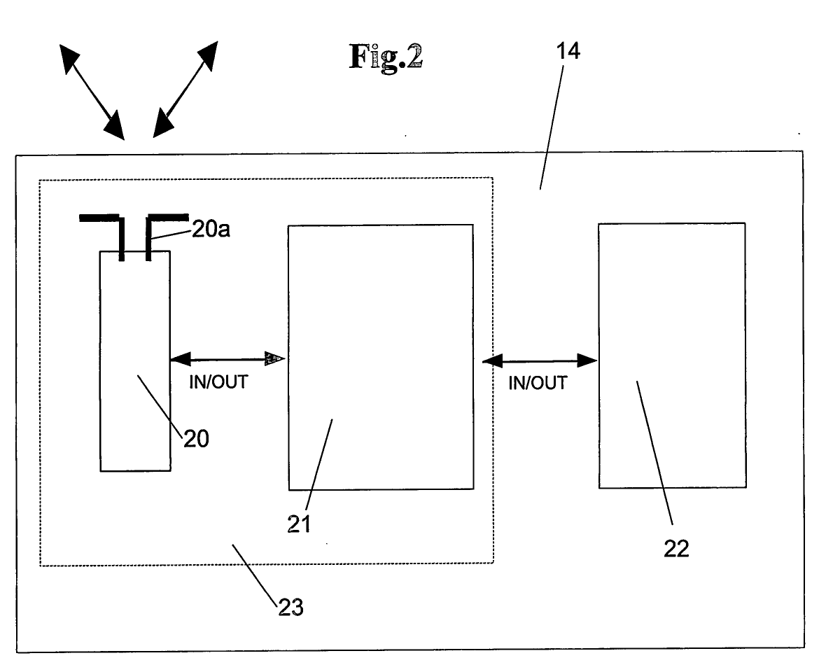

The diagram of FIG. 2 details the architecture of a transmitter/receiver millimetre-wave WLAN station. This applies in a substantially identical manner to the various stations 14 with millimetre-wave card shown in FIG. 1 and to the access points 13 as well.

Essentially, the architecture of FIG. 2 is comprised of three basic elements, namely:
a millimetre-wave transceiver 20 provided with an antenna 20a,
a net-WLAN module 21 usually mounted jointly with the transceiver 20 on a millimetre-WLAN card 23, and
a processor unit 22 which, in the case of the stations 14, may be e.g. a personal computer or portable telephone or another type of terminal.

The elements 20 and 21 including the antenna 20a for the transceiver 20 are preferably mounted on the card 23 in a configuration adapted to permit insertion into the input/output module 22, for instance by PCI bus.

The millimetre-wave transceiver module 20 can be of the type described in the article by Y. Mimino et al., “A 60 GHz Millimeter-wave MMIC Chipset for Broadband Wireless Access System Front-end”-2002 IEEE MTT-S. Digest TH3A-2 or in the article by K. Fujii et al., “60 GHz-MMIC Chipset for l-Gbit/s Wireless Links”-2002 IEEE MTT-S. Digest TH3A-3.

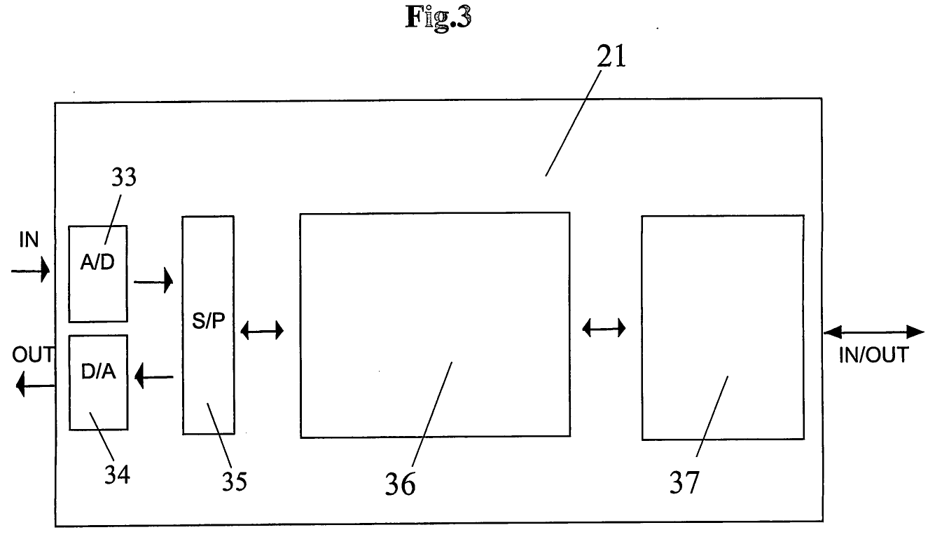

As better detailed in FIG. 3, the module 21 includes high-frequency analogue-to-digital and digital-to-analogue converters 33 and 34, respectively. These are connected to a serial-to-parallel converter 35 (for instance a shift register), a millimetre-WLAN general management unit 36 (to be described in greater detail in the following) and a medium access control (MAC) unit 37.

Advantageously, the converters 33 and 34 are of the type currently available as HYPRES, Inc. cryogenic devices or are based on 0.13 micron CMOS technology.

As indicated, the description provided in the foregoing applies both to the stations 14 and the access points 13.

In case of access point 13, the processor module 22 may be e.g. a control unit adapted, in a known way, to manage traffic control between the stations 14.

However, the MAC 37 included in the net WLAN module 21 is more complex in the case of the access points 13 than in the case of the stations 14. Also, in the case of the access points 13 the MAC unit 37 is generally required to operate at higher speeds, which is compatible with current technologies such as Gigabit-Ethernet switch technology currently available with CISCO SYSTEMS, Inc.

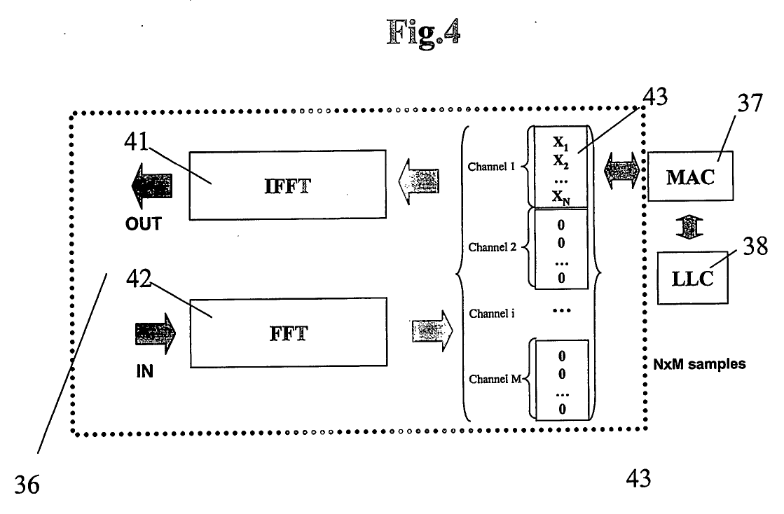

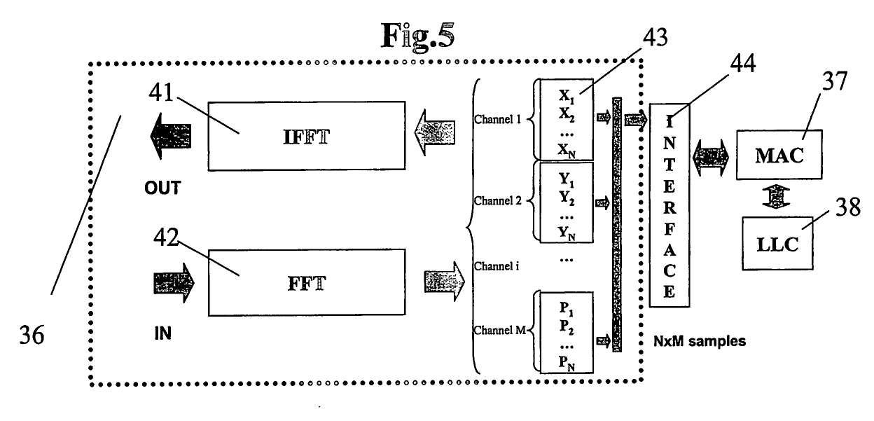

Architecture and operation of the channel management units 36 is substantially similar in the case of the local stations (FIG. 4) and in the case of the access points 13 (FIG. 5).

Each local station module 23 is essentially required to manage data flows from and to the respective processor unit or terminal 22. Conversely, each access point 13 will simultaneously manage data flows to and from all the stations 14 located in the area 12 served by the access point in question.

An orthogonal frequency domain multiplex (OFDM) scheme is essentially based on the joint use of an integral transform (such as a Fast Fourier Transform or FFT) and the complementary inverse transform (such as the Inverse Fast Fourier Transform or IFFT).

Both FIGS. 4 and 5 refer to the use of FFT in reception and the use of IFFT in transmission which is the conventional representation of OFDM. Those of skill in the art will however appreciate that any type of integral transform admitting a complementary inverse transform can be used for implementing an OFDM scheme.

The IFFT transmission modules 41 and FFT reception modules 42 shown in FIGS. 4 and 5 carry out orthogonal frequency division multiplexing (OFDM) operations.

The modules in question can be advantageously constituted by Fast Math Processors available with Intrinsity, Inc.

In both FIGS. 4 and 5, reference 43 designates buffer unit that manages the input and output samples by converting them from parallel to serial form and vice versa. The buffer unit 43 is typically comprised of a shift register.

Reference numerals 38 and 37 designate a logical link control (LLC) block and the MAC block, respectively.

The LLC block 38 is typically a module referred to the upper part of the second level of the standard open system interconnection (OSI) model. Essentially, the module 38 and the MAC module 37 together represent the data link layer of the OSI model and perform the driver functionalities for the millimetre-wave card.

Both in the local stations 14 and in the access points 13 the MAC level is implemented on the network card 23, while the logical link control layer is typically comprised of a software module contained in the processor unit 22.

Operation of the system just described is based on a time division duplex (TDD) pattern, wherein the transmission and reception phases are allotted respective time slots. Hardware components such as buffers and serial-to-parallel converters can thus be re-used both in transmission and in reception.

Essentially, the transceiver module 20 receives via its antenna 20a the wireless signal and delivers it to the net-WLAN module 21. There the signal is processed and converted to a form compatible with the upper levels of the OSI model (essentially, the LLC and the TCP/IP levels in the processor unit 22).

In a symmetrical way, the processor unit 22 delivers its output signals to the net-WLAN module 21, which converts such signals to a transmission format adapted to the transceiver module 20.

More specifically, signals from the millimetre-wave transceiver module 20 are processed by the analogue-to-digital converter 33 and converted into the parallel form in the serial-to-parallel converter 35. The corresponding samples are then processed in the channel management block 36. The output samples from the block 36 are then delivered to the MAC level 38 for their final destination to the processor unit 22.

The signals being transmitted follow exactly the same path in the opposite direction (in different time slots for a TDD operation mode) and are sent to the transceiver module 20 through the digital-to-analogue converter 34.

Considering first the data output from a local station (FIG. 4), the data to be transmitted are grouped in M sets of N samples and sent into the buffer 43 including locations for N×M samples.

In fact, out of the N×M positions available in the buffer 43, only N positions are reserved for samples conveying a signal. These samples conveying the signal to be transmitted are currently referred to briefly as “non-zero” samples, even though—strictly speaking—they may possibly include one or more samples corresponding to a zero-level signal.

In conventional OFDM transmission, the N non-zero samples are usually allotted—the same—position within the buffer 43. Typically, this position corresponds to the first N positions within the buffer.

In conventional OFDM systems, this applies to all local stations 14. Consequently, transmission of data from the various local stations 14 (and, similarly, transmission of signals towards the various local station 14) must be staggered over time by causing transmission from or to each single local station to take place within a given time interval.

As opposed thereto, the arrangement described herein essentially considers the N×M positions available in the buffer 43 as representing M channels each adapted for transmitting N samples.

Consequently, in the arrangement described herein, a given local station (hereinafter “station 1”) will place its N non-zero samples X₁ X₂ . . . , X_{N} to be transmitted at a given instant of time in the first N positions of the buffer 43, such first N positions representing a first channel in the OFDM scheme of the arrangement shown herein.

Another station (hereinafter “station 2”), will place its set of N non-zero samples to be transmitted at the same instant of time in the positions X_{N+1} to X_{2N} in the buffer 43, these N positions, being non-overlapping with the positions X₁ to X_{N} allotted to “station 1”, representing a second channel in the system.

Proceeding similarly for all the other stations in the system, a M-th local station will finally place a respective set of N samples to be transmitted at the same instant of time in the positions X_{N×(M-1)+1} and X_{N×M} of the buffer 43, these N positions, being non-overlapping with the positions X₁ to X_{N} allotted to “station 1”, the positions X_{N+1} to X_{2N} allotted to “station 2” and so on, representing a M-th channel in the system.

Stated otherwise, each local station 14 will include in the respective channel management module 36 a buffer such as buffer 43, with the proviso that the i-th local station 14 will be allotted the i-th channel within the OFDM transmission scheme, such a channel being in fact represented by a respective set of N positions assigned (in a non-overlapping manner with those sets allotted to other stations) in the buffer 43.

The i-th local station in question will put its N non-zero samples to be transmitted at a given time at those N positions of the buffer 43 representing the channel allotted to that station, while all the other positions in the buffer 43 will be forcibly set to zero.

The N×M sample sets thus created (including N non-zero samples and N×(M−1) samples forced to zero) will then be processed according to the standard OFDM processing procedure by subjecting it to the Inverse Fast Fourier Transform IFFT in the module 41 to be then serialized in the module 35 and transmitted to the digital-to-analogue converter 34.

The output signal thus generated will then be used to modulate the millimetre-wave module 20 and then transferred to the antenna 20a for wireless transmission within the WLAN.

The samples associated with a channel of interest will thus be defined in the frequency domain (like in prior-art OFDM systems) and separated in the buffer 43 by selecting the correct channel allotted in a non-overlapping manner to a given local station, this operation being easily accomplished by the MAC module 38.

After IFFT processing, in view of the spectrum separation, the information transmitted in respect of each and every channel defined in the buffer 43 will not be affected by interference with the information transmitted from other local stations by using other channels, namely other groups of samples within the respective buffers 43.

The signals so transmitted (during the same time interval) by the various local stations 14 will be received at the access point 13 serving the respective local area.

After reception in the module 20, the signal will be subject to analogue-to-digital conversion in the module 33 and then re-arranged from the serial to the parallel format in the module 35 to be subject to Fast Fourier Processing in the module 42.

As a result of this, the input samples will be reconverted to the frequency domain and, because of their definition, will be loaded in the buffer 43 of the access point 13 in distinct, non-overlapping sections of the buffer 43. The buffer 43 in the access point 13 will include M such sections, each adapted to correspond to a given transmission channel.

Each channel will in turn include N samples pertaining to transmission toward the access point 13 from a given local station 14 without interference.

Information achieved in the reception phase is delivered to the upper levels of the corresponding OSI model, namely the MAC module 37 and the LLC module 38.

Of course, the access point acting as a receiver will have to match the incoming samples associated with the various transmitting stations with output buffer intervals corresponding to the channel of destination, namely the local station transmitting the respective signal. An interface module 44 interposed between the buffer 43 and the MAC and LLC modules 37 and 38 easily achieves such a task.

Transmission from the access point 13 to the various local stations 14 will take place according to the same criteria described in the foregoing.

The samples to be transmitted to the various local stations (for instance, M sets of N samples each) will be loaded via the interface 44 into the buffer 43 by arranging the N samples intended to be transmitted to “station 1” in the first N positions of the buffer 43, the N samples intended to be transmitted to “station 2” in the positions N+1 to N of the same buffer, and so on proceeding for the remaining stations in a non-overlapping manner.

After transmission (taking place within the same interval for all stations 14) OFDM processing as described in the foregoing will lead each local station 14 to have its buffer 43 (acting as a reception buffer) filled with N generally non-zero samples located in the positions corresponding to the channel assigned to that station.

Operation as described permits communication from the various local stations 14 to the access point 13 and from the access point 13 to the various local stations 14 to take place simultaneously (namely without any need of staggering transmission to and from separate stations over different time intervals), the only requirement being that proper synchronization is ensured when transmitting the blocks of N×M samples. This result can be achieved by known means, e.g. by resorting to a so-called “beacon” signal.

In a millimetre-wave WLAN system with a 4 GHz bandwidth between 58 and 62 GHz, a preferred choice of the system parameters is as follows:
4 GHz band around a 60 GHz carrier;
M=16 number of channels/stations, that may simultaneously transmit in an area covered by an access point;
N=64 number of sub-carriers in one single channel (the OFDM features of multipath rejection, strictly depending on this parameter, are therefore maintained;
64×16=1.024 number of overall samples in the FFT/IFFT modules;
250 MHz: band available for each channel;
150 Mbit/s, minimum bit rate achievable for each station.

It will be appreciated that the arrangement just disclosed combined the advantages of traditional OFDM techniques (effectively combating multipath propagation effects, fast fading in free-space propagation and frequency-selective channels) with the simplicity of digital frequency multiplexing.

Additionally, local oscillators and mixers are not required for modulating the channels as channel selection is achieved spatially, by selecting the right interval of samples. This affords a great flexibility in band allocation and association with different local stations. Thanks to contiguous positioning of the transmission samples, two or more channels can be joined to form a “wider” channel, which leads to increased additional resources.

Multiplexing can be managed completely at the software level, with increased flexibility towards upper levels of the reference OSI model, which leads a simplification of the interface between the physical level and the data link-MAC.

Division of information and its allocation to the right channel is managed in a completely digital manner by using FFT and IFFT for channel selection. Additionally, the OFDM multiplexing function is integrated with the FFT and IFFT signal processing, while the interval of samples allotted to each station is dynamically selected at the MAC level.

Modularity in the multiplexing structure can be achieved with the possibility of joining channels without changing the system architecture. The MAC level identifies each single channel with a value used to detecting the buffering sample interval. This allows dynamic selection of the channel of interest operated by the MAC level such a result being obtained simply with the selection of a specific group of received samples.

Although the described example relates to a millimetre wave WLAN, the invention equally applies to other types of network, for example sub-millimetre wave WLAN, WLAN using other frequency bands or, in general, digital local area networks.

Of course, without prejudice to the underlined principle of the invention, the details and embodiment may vary, even significantly, with respect to what has been described and shown, without departing from the scope of the invention as defined by the annexed claims.

1-22. (canceled)

23. A method of managing a transmission system wherein a plurality of sets of samples (N×M) is subject to an integral transform transmitted in said integral-transformed format and subject to a complementary integral transform to reconstruct said plurality of set of samples (N×M), comprising the steps of:
including in said system a plurality of terminals;
assigning to said terminals respective non-overlapping sets of samples or positions within said plurality of sets of samples; and
transmitting a set (X₁, X₂, . . . X_{N}) of non-zero samples pertaining to a first terminal of said plurality by inserting said samples in the respective position assigned to said first terminal.

24. The method of claim 23, further comprising the steps of:
including in said system at least one further terminal adapted for exchanging samples with said plurality of terminals;
causing said at least one further terminal to subject to at least one of said integral transform and said complementary integral transform a plurality of sets of samples including at least two non-overlapping sets of non-zero samples, said two non-overlapping sets of samples pertaining to two respective different terminals of said plurality.

25. The method of claim 23, wherein said integral transform is selected from the group of the Fast Fourier Transform (FFT) and the Inverse Fast Fourier Transform (IFFT).

26. The method of claim 23, further comprising the steps of transmitting said samples in said integral transformed format over a millimetre-wave carrier.

27. The method of claim 26, wherein said millimetre-wave carrier is selected in the frequency range of 60 GHz.

28. A transmission system comprising:
an integral transform module for subjecting a plurality of sets of samples including at least one set (X₁, X₂, . . . X_{N}) of a non-zero sample to an integral transform;
a transmitter for transmitting assigned non-overlapping sets comprising at least one set (X₁, X₂, . . . X_{N}) of samples in said integral-transformed format;
a receiver for receiving said sets of samples transmitted in said integral-transformed format; and
a complementary integral transform module for subjecting said samples transmitted in said integral-transformed format as received by said receiver to a complementary integral transform and reconstructing therefrom said at least one set of non-zero samples.

29. The system of claim 28, wherein at least one terminal having assigned a non-overlapping set of samples or position within said plurality of sets of samples and comprising at least one of:
said integral transform module and said transmitter; or
said receiver and said complementary integral transform module.

30. The system of claim 28, further comprising at least one further terminal adapted for exchanging samples with said plurality of terminals, said at least one further terminal including at least one of said integral transform module and complementary integral transform module for subjecting to at least one of said integral transform and said complementary integral transform sets of samples including at least two non-overlapping sets of non-zero samples, non-overlapping sets of samples pertaining to two respective different terminals of said plurality.

31. The system of claim 30, in the form of a WLAN network, wherein at least one further terminal is an access point of said WLAN network.

32. The system of claim 28, wherein at least one of a transmitter and receiver operates over a millimetre-wave carrier.

33. The system of claim 32, wherein at least one of a transmitter and receiver operates over a carrier in the frequency range of 60 GHz.

34. A transmitter terminal for the transmission system of claim 28, comprising:
a buffer for receiving said plurality of sets of samples;
an integral transform module for subjecting said plurality of sets of samples in said buffer to an integral transform to generate signals to be transmitted in an integral transformed format; and
sample allocation circuitry for selectively arranging at least one set of generally non-zero samples to be transmitted in a respective position of said buffer.

35. The transmitter terminal of claim 34, wherein allocating circuitry is configured for allocating at least a single set of generally non-zero samples in a single, respective set of positions of said buffer, said set allocation being indicative of said transmitter terminal.

36. The transmitter terminal of claim 33, comprising an RF module operating in the millimetre-wave range.

37. The transmitter terminal of claim 36, wherein said RF module operates in the range of 60 GHz.

38. A receiver terminal for the transmission system of claim 28, comprising:
a receiver for receiving samples transmitted in said integral-transformed format;
a buffer for receiving said plurality of sets of samples;
a complementary integral transform module for subjecting said sets of samples in said buffer to a complementary integral transform and reconstructing therefrom said at least one set of generally non-zero samples; and
sample allocation circuitry for selectively arranging at least one set of generally non-zero samples in a respective position of said buffer.

39. The receiver terminal of claim 38, wherein said allocating circuitry is configured for allocating at least a single set of generally non-zero samples in a single, respective set of positions of said buffer, said set allocation being indicative of the transmitter.

40. The receiver terminal of claim 38, comprising a receiver operating in the millimetre-wave range.

41. The receiver terminal of claim 40, wherein said receiver operates in the range of 60 GHz.

42. A computer program product directly loadable in the internal memory of a computer and including software code portions performing the method of claim 23, where said product is capable of running on a computer.

43. A computer program product directly loadable in the internal memory of a computer and including software code portions for implementing the transmitter terminal of claim 34, where said product is capable of running on a computer.

44. A computer program product directly loadable in the internal memory of a computer and including software code portions for implementing the receiver terminal of claim 38, where said product is capable of running on a computer.
